(19) United States
(12) Patent Application Publication
(10) Pub. No.: US 2005/0207608 A1
(43) Pub. Date: Sep. 22, 2005

(54) Gasket for speaker

(75) Inventors: Hiroyuki Kobayashi, Yamagata-ken (JP); Kenichi Kasahara, Yamagata-ken (JP); Shinichi Hayasaka, Yamagata-ken (JP); Toshihiro Hikichi, Yamagata-ken (JP)

Correspondence Address: ARENT FOX PLLC, 1050 CONNECTICUT AVENUE, N.W., SUITE 400, WASHINGTON, DC, 20036, US

(73) Assignees: Pioneer Corporation; Tohoku Pioneer Corporation

(21) Appl. No.: 11/081,590

(22) Filed: Mar. 17, 2005

(30) Foreign Application Priority Data
Mar. 18, 2004 (JP) JP2004-78846

(51) Int. Cl. H04R 25/00

(52) U.S. Cl. 381/392

(57) ABSTRACT

A speaker gasket formed in a required shape out of elastic materials such as rubber has a plurality of bolt-through holes formed at regular intervals. The speaker gasket is formed with varying thicknesses, for example, in a such manner that the central portion in the width direction is formed with thickness greater or smaller than that of the portions on either side of the central portion; a plurality of recesses are formed; or the surfaces of the speaker gasket has a sawtooth waveform in the width direction.

### BACKGROUND OF THE INVENTION

1. Field of the Invention

This invention relates to a gasket used for installing a speaker and forming a seal between the speaker and a speaker-mounting site.

The present application claims priority from Japanese Application No. 2004-78846, the disclosure of which is incorporated herein by reference.

2. Description of the Related Art

When speakers are installed in a required site, for example, when in-vehicle speakers are mounted in vehicle doors, the formation of a seal between the speaker and the speaker-mounting site is typically needed for preventing water or moisture from coming in through the gap between the speaker and the speaker-mounting site.

FIG. 1 shows a conventional gasket for forming a seal between a speaker and a speaker-mounting site. The speaker gasket 1 is formed in a ring shape having four bolt-through holes 1a formed therein.

As shown in FIG. 2, the speaker gasket 1 shown in FIG. 1 is interposed between a frame SPa of the speaker SP and the rim of a speaker-mounting opening 2a formed in an inner panel 2 of a vehicle or the like. The speaker gasket 1 is clamped between the frame Spa and the inner panel 2 which are bolted together, to prevent the entry of water or moisture into the inside of the inner panel 2 from the site in which the speaker SP is installed.

Such a conventional speaker gasket is described in Japanese Paten Laid-open application No. 2001-352590, for example.

However, the conventional speaker gasket 1 is formed of an equal thickness throughout. Therefore, when the speaker gasket 1 is placed between the speaker frame SPa and the inner panel 2 and clamped with bolts B, the clamping stress is concentrated on the part clamped by the bolt B (around the hole 1a), to cause a phenomenon of reducing the force of the contact pressure of the speaker gasket 1 against the speaker frame SPa and the inner panel 2 in the areas between the positions of adjacent clamping bolts B, as illustrated in FIG. 3.

For this reason, in the conventional speaker gasket 1, the sealing function in the areas between the adjacent clamping positions of the bolts B may possibly be reduced so far as to permit the entry of water or moisture into the inner panel 2 through these clamping positions.

### SUMMARY OF THE INVENTION

An object of the present invention is to solve the problem associated with the conventional speaker gasket as described above.

To attain this object, a speaker gasket according to the present invention is interposed between a speaker-mounting site and a speaker frame, and clamped between the speaker-mounting site and the speaker frame by fixtures inserted through fixture-through holes to form a seal between the speaker-mounting site and the speaker frame. The speaker gasket is characterized by comprising varying thicknesses in either a width direction or a circumferential direction of the speaker gasket.

In the best mode for carrying out the present invention, a speaker gasket is formed in a required shape out of elastic materials such as rubber, has a plurality of bolt-through holes formed at regular intervals in the longitudinal direction, and is further formed with varying thicknesses throughout the areas extending between adjacent bolt-through holes: for example, the thickness of a central portion in the width direction is smaller than that of the portions on either side of the central portion; the thickness of a central portion between the bolt-through holes in the circumferential direction is formed greater than that of a portion in which the bolt-through hole is formed; a plurality of recesses are arranged in the longitudinal direction of the speaker gasket in at least one of the surfaces of the speaker gasket, either that which comes into contact with the speaker mounting site or that which comes into contact with the speaker frame, and the bolt-through holes are formed in the recesses; and at least one of the surfaces of the speaker gasket, either that coming into contact with the speaker mounting site or that coming into contact with the speaker frame, has a sawtooth waveform in the width direction of the speaker gasket.

The speaker gasket in this mode is interposed between a speaker frame and the rim of a speaker mounting opening formed, for example, in an inner panel of a vehicle, and then clamped with bolts inserted through the bolt-through holes of the speaker gasket as well as through the inner panel and the speaker frame, thereby forming a seal between the speaker panel and the inner panel or the like.

At this point, because the speaker gasket is formed in a shape with varying thickness, the face of the thick portion of the gasket surface is in pressure contact with the inner panel or the speaker frame at all times and is subject to the application of pressure. For this reason, the clamping stress induced by the bolts is spread over the speaker gasket without concentrating on the vicinity of the bolt-through hole.

The speaker gasket, therefore, makes it possible to eliminate the reduction in sealing function which has been conventionally caused by the concentration of the clamping stress induced by the bolts, and achieve effective watertight capability in the speaker-mounting site.

These and other objects and features of the present invention will become more apparent from the following detailed description with reference to the accompanying drawings.

### BRIEF DESCRIPTION OF THE DRAWINGS

FIG. 1 is a plan view of a conventional speaker gasket.

FIG. 2 is a view illustrating the state in which the conventional speaker gasket is mounted.

FIG. 3 is an enlarged sectional view illustrating the state in which the conventional speaker gasket is mounted.

FIG. 4 is a plane view illustrating a first embodiment of the present invention.

FIG. 5 is a sectional view taken along the V-V line in FIG. 4.

FIG. 6 is a sectional view taken along the VI-VI line in FIG. 4.

FIG. 7 is a sectional view illustrating the state in which a speaker gasket of the first embodiment is mounted.

FIG. 8 is a plane view illustrating a second embodiment of the present invention.

FIG. 9 is a sectional view taken along the IX-IX line in FIG. 8.

FIG. 10 is a sectional view taken along the X-X line in FIG. 8.

FIG. 11 is a plane view illustrating a third embodiment of the present invention.

FIG. 12 is a sectional view taken along the XII-XII line in FIG. 11.

FIG. 13 is a plane view illustrating a fourth embodiment of the present invention.

FIG. 14 is a sectional view taken along the XIV-XIV line in FIG. 13.

FIG. 15 is a sectional view taken along the XV-XV line in FIG. 13.

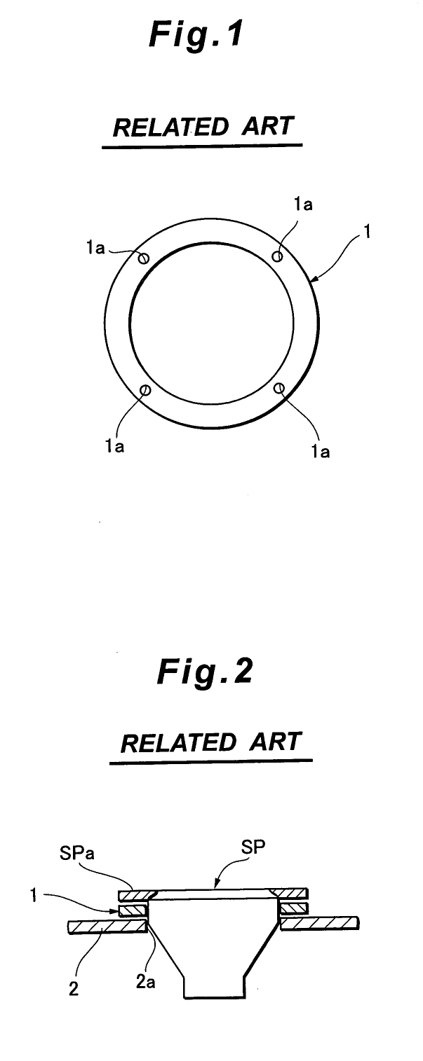

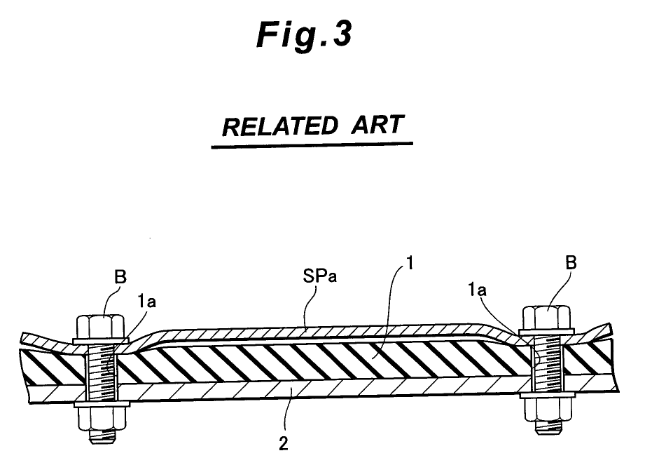

### DETAILED DESCRIPTION OF THE PREFERRED EMBODIMENTS

### First Embodiment

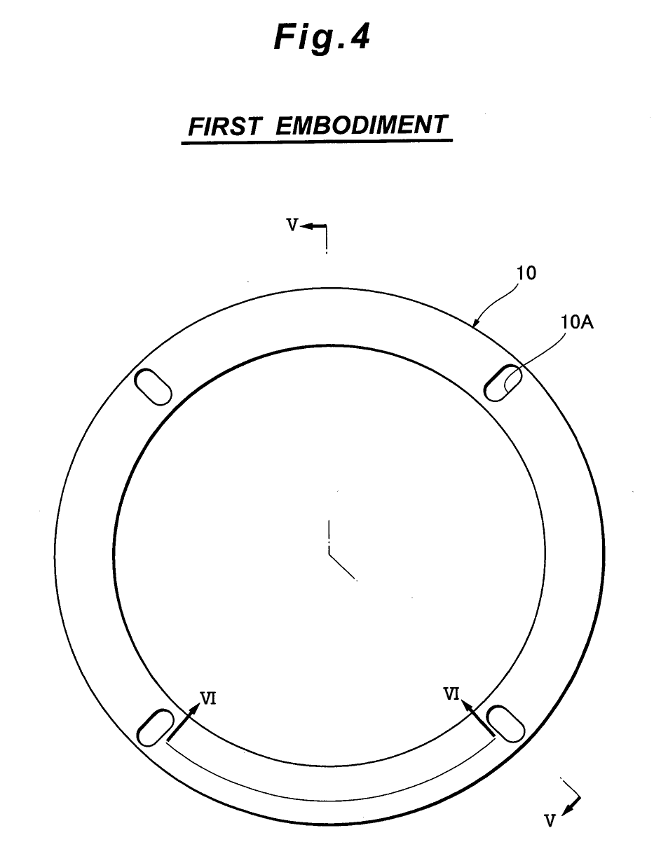

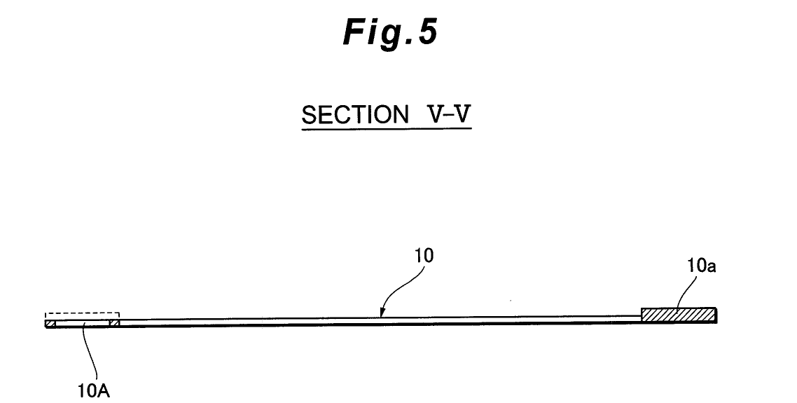

FIG. 4 and FIG. 5 illustrate a first embodiment of a speaker gasket according to the present invention. FIG. 4 is a plan view of the speaker gasket 10 according to the first embodiment, and FIG. 5 is a sectional view taken along the V-V line in FIG. 4.

In FIGS. 4 and 5, the speaker gasket 10 is formed in a ring shape having a required width in the radial direction by a method of heating and vulcanizing rubber of a hardness from 60 degrees to 45 degrees, for example.

The speaker gasket 10 has four bolt-through holes 10A formed at equal angular intervals and extending through the speaker gasket 10 in the axis direction.

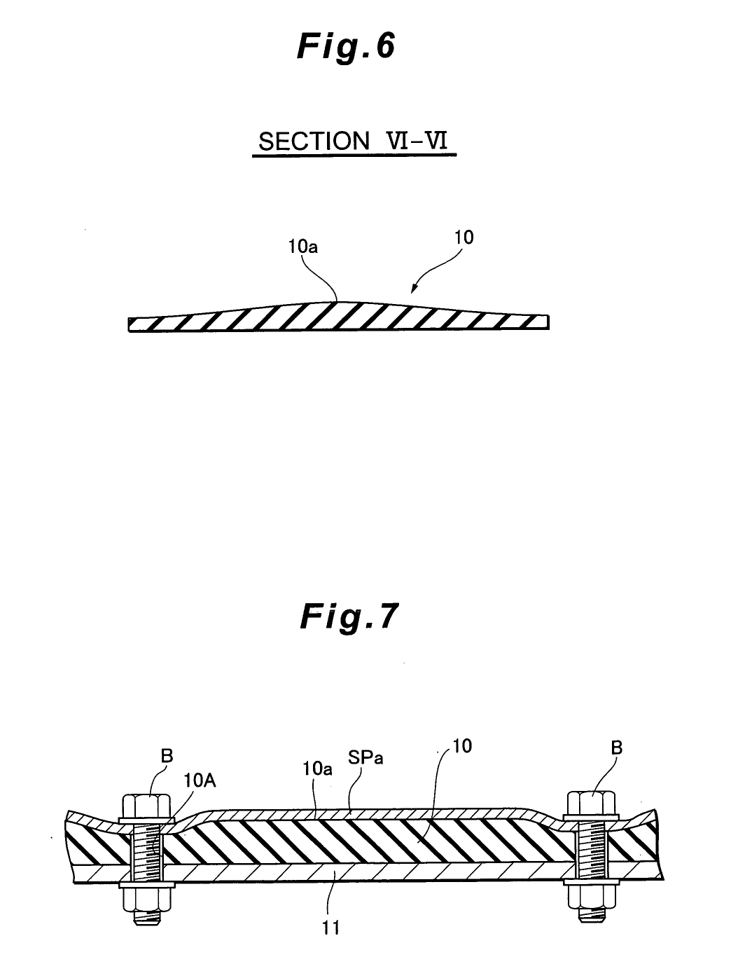

As enlarged and illustrated in FIGS. 5 and 6, the speaker gasket 10 has swells 10a each integrally formed in a central portion between the bolt-through holes 10A on one of the surfaces. The swell 10a rises above the portion where the bolt-through holes 10A are formed on both sides of the swell 10a.

FIG. 7 is a sectional view taken along the circumferential direction of the speaker gasket 10 when the speaker gasket 10 is interposed between a panel 11 on which the speaker is installed and the speaker frame SPa and clamped between and together with the panel 11 and speaker frame SPa with bolts B which are inserted through the bolt-through holes 10A.

As shown in FIG. 7, when the speaker gasket 10 is interposed and clamped between the panel 11 and the speaker SPa with the bolts B passing through the bolt-through holes 10A, a uniform pressure is applied to the speaker frame SPa (or the panel 11) to thereby make the clamping stress induced by the bolts B uniform across the entire circumference of the speaker gasket 10.

Accordingly, the speaker gasket 10 enables the elimination of a reduction in sealing function between the adjacent bolt clamping positions as in the conventional case, thus making the effective watertight capability in the speaker-mounting position possible.

### Second Embodiment

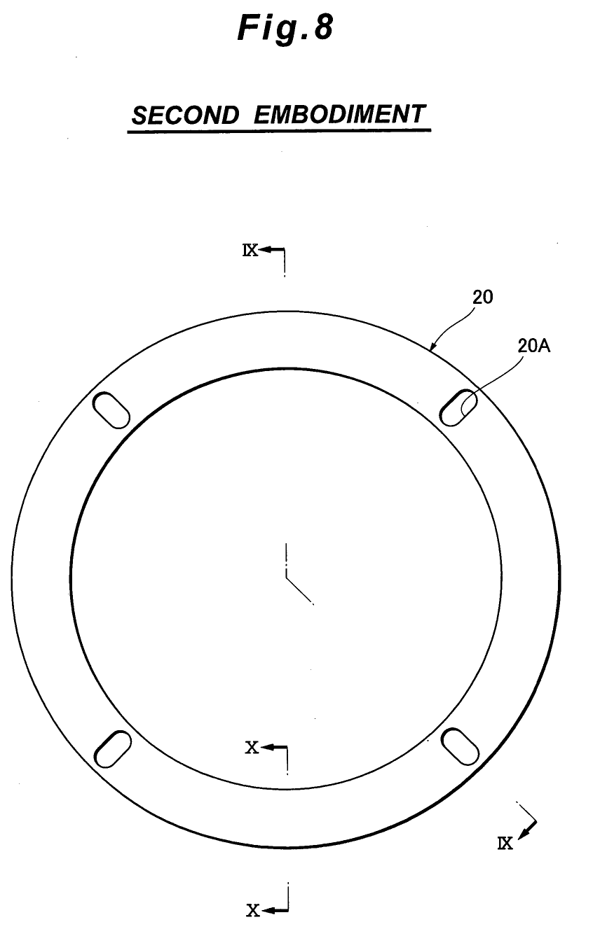

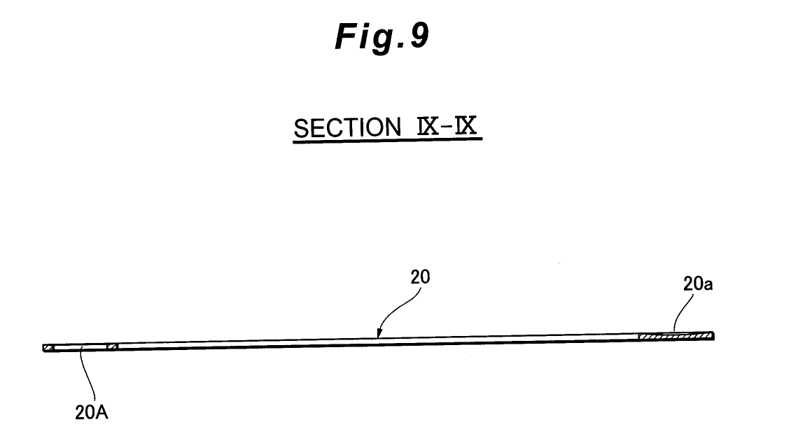

FIG. 8 and FIG. 9 illustrate a second embodiment of a speaker gasket according to the present invention. FIG. 8 is a plan view of the speaker gasket 20 according to the second embodiment, and FIG. 9 is a sectional view taken along the IX-IX line in FIG. 8.

In FIGS. 8 and 9, as in the case of the speaker gasket 10 in the first embodiment, the speaker gasket 20 is formed in a ring shape having a required width in the radial direction by a method of heating and vulcanizing rubber of a hardness from 60 degrees to 45 degrees, for example.

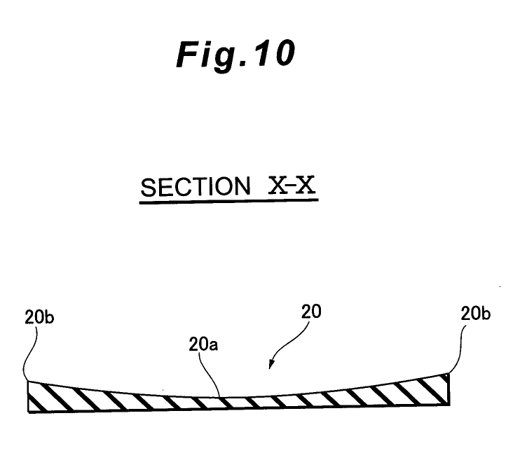

As enlarged and illustrated in FIG. 10, the speaker gasket 20 has recesses 20a integrally formed along the entire circumference on one of the surfaces. The recess 20a is formed in an arc shape in which the central portion in the radial direction of the speaker gasket 20 is recessed lower than the inside circumferential portion and the outside circumferential portion.

The speaker gasket 20 further has four bolt-through holes 20A drilled at equal angular intervals through the speaker gasket 20 in the axis direction.

As in the case of the speaker gasket 10 of the first embodiment, the speaker gasket 20 is placed between a speaker frame of a speaker and a panel on which the speaker is mounted and then clamped with bolts inserted through the bolt-through holes 20A (see FIG. 7). At this point, the inside and outside circumferential portions 20b on both sides of the recess 20a on the surface of the speaker gasket 20 come into pressure contact with the speaker frame (or the panel) and become subject to the application of pressure. For this reason, the clamping stress induced by the bolts is spread across the entire circumference of the speaker gasket 20.

Accordingly, the speaker gasket 20 enables the elimination of a reduction in sealing function between the adjacent bolt clamping positions as in the conventional case, thus making effective watertight capability in the speaker-mounting position possible.

### Third Embodiment

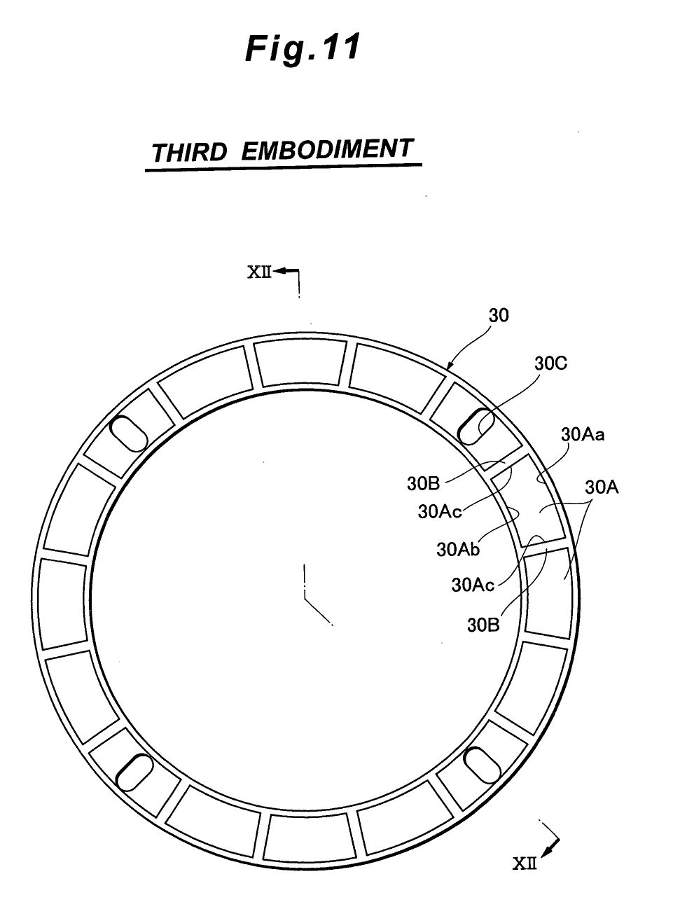

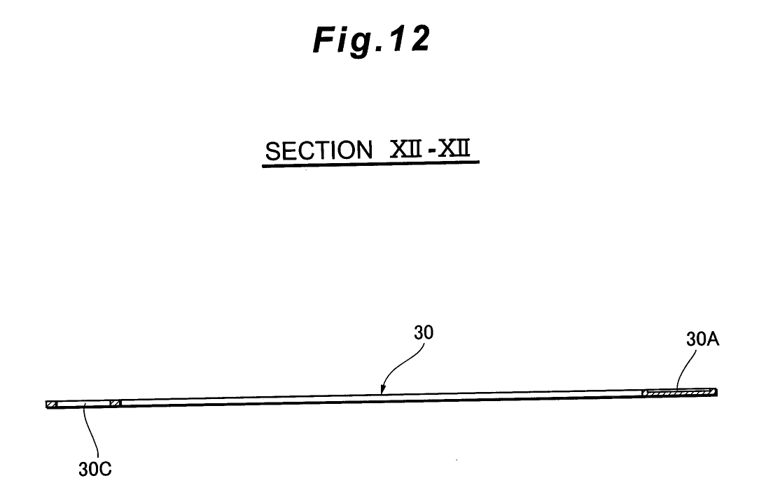

FIG. 11 and FIG. 12 illustrate a third embodiment of a speaker gasket according to the present invention. FIG. 11 is a plan view of the speaker gasket 30 according to the third embodiment, and FIG. 12 is a sectional view taken along the XII-XII line in FIG. 11.

In FIGS. 11 and 12, as in the case of the speaker gasket 10 in the first embodiment, the speaker gasket 30 is formed in a ring shape having a required width in the radial direction by a method of heating and vulcanizing rubber of a hardness from 60 degrees to 45 degrees, for example.

The speaker gasket 30 has a plurality of recesses 30A formed at regular intervals along the entire circumference on one of the surfaces.

Regarding each of the recesses 30A, the opening is defined by an outside circumference-side edge 30Aa and an inside circumference-side edge 30Ab each extending in an arc pattern concentrically with the speaker gasket 30, and two ends 30Ac each extending linearly and parallel to the radial direction of the speaker gasket 30.

A dividing wall 30B is provided to form a partition between adjacent recesses 30A.

The speaker gasket 30 further has bolt-through holes 30C respectively formed in the four recesses 30A located at equal angular intervals and drilled through the speaker gasket 30 in the axis direction.

As in the case of the speaker gasket 10 of the first embodiment, the speaker gasket 30 is placed between a speaker frame of a speaker and a panel on which the speaker is mounted and then clamped with bolts which are inserted through the bolt-through holes 30C. At this point, the peripheral parts of the recesses 30A formed at equal angular intervals on the surface of the speaker gasket 30 come into pressure contact with the speaker frame (or the panel). For this reason, the clamping stress induced by the bolts is spread across the entire circumference of the speaker gasket 30, and also the recesses 30A are absorbed in a suction-cup manner.

Accordingly, with the use of the speaker gasket 30, a reduction in sealing function between the adjacent bolt clamping positions as in the conventional case is eliminated to make effective watertight capability in the speaker-mounting position possible.

### Fourth Embodiment

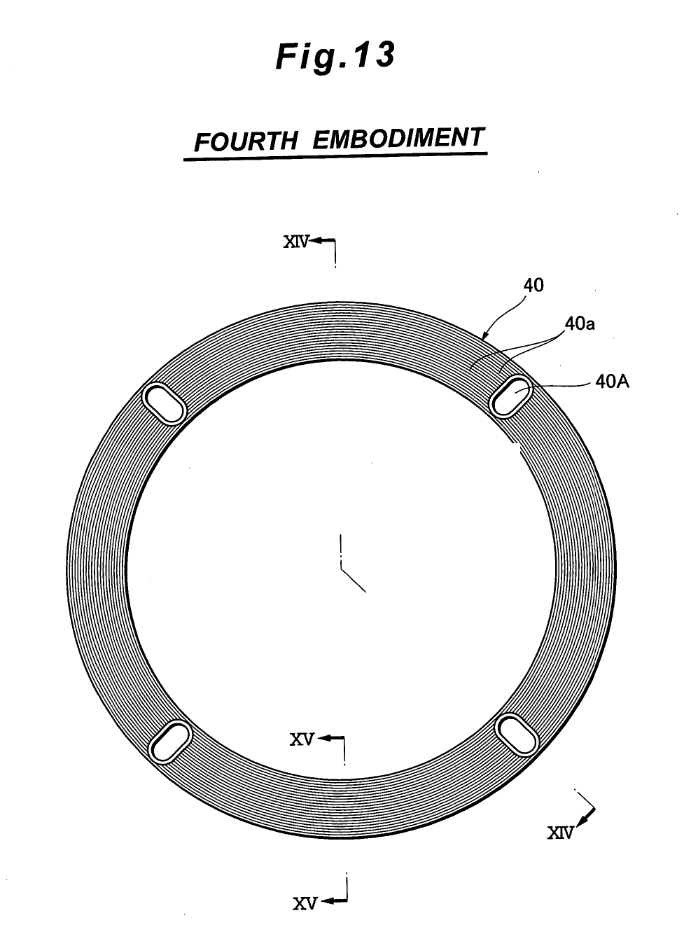

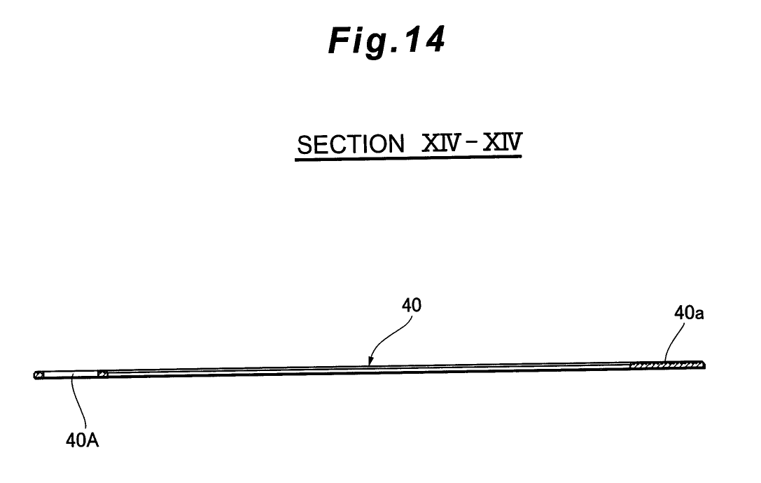

FIG. 13 and FIG. 14 illustrate a fourth embodiment of a speaker gasket according to the present invention. FIG. 13 is a plan view of the speaker gasket 40 according to the fourth embodiment, and FIG. 14 is a sectional view taken along the XIV-XIV line in FIG. 13.

In FIGS. 13 and 14, as in the case of the speaker gasket 10 in the first embodiment, the speaker gasket 40 is formed in a ring shape having a required width in the radial direction by a method of heating and vulcanizing rubber of a hardness from 60 degrees to 45 degrees, for example.

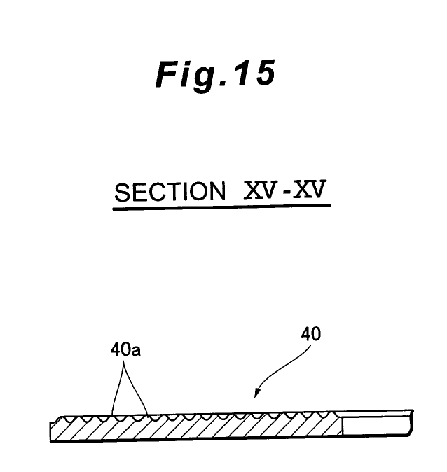

The speaker gasket 40 has sawteeth 40a formed on one of the surfaces. The sawteeth 40a extend along the circumference concentric with the speaker gasket 40, and, as enlarged in FIG. 15, are arranged in such a manner as to overlap each other in the radial direction of the speaker gasket 40.

The speaker gasket 40 further has four bolt-through holes 40A formed at equal angular intervals and drilled through the speaker gasket 40 in the axis direction.

As in the case of the speaker gasket 10 of the first embodiment, the speaker gasket 40 is placed between a speaker frame of a speaker and a panel on which the speaker is mounted and then clamped with bolts inserted through the bolt-through holes 40A. At this point, the leading ends of the respective sawteeth 40a formed on the surface of the speaker gasket 40 come into pressure contact with the speaker frame (or the panel). For this reason, the clamping stress induced by the bolts is spread across the entire circumference of the speaker gasket 40.

Accordingly, with the use of the speaker gasket 30, a reduction in seal function between the adjacent bolt clamping positions as in the conventional case is eliminated, and thus effective watertight capability in the speaker-mounting position is made possible.

The terms and description used herein are set forth by way of illustration only and are not meant as limitations. Those skilled in the art will recognize that numerous variations are possible within the spirit and scope of the invention as defined in the following claims.

1. A speaker gasket interposed between a speaker-mounting site and a speaker frame and clamped between the speaker-mounting site and the speaker frame by fixtures inserted through fixture-through holes to form a seal between the speaker-mounting site and the speaker frame, comprising
varying thicknesses in either a width direction or a circumferential direction of the speaker gasket.

2. A speaker gasket according to claim 1, wherein the thickness of a central portion of the speaker gasket between the fixture-through holes in the circumferential direction is greater than that of a portion in which the fixture-through hole is formed.

3. A speaker gasket according to claim 2, wherein the speaker gasket is formed in a ring shape and has a plurality of the fixture-through holes formed in positions spaced at equal angular intervals in the ring-shaped speaker gasket, and the thickness of the central portion between the fixture-through holes in the circumferential direction is greater than that of the portion in which the fixture-through hole is formed, throughout areas extending between adjacent fixture-through holes of the ring-shaped speaker gasket.

4. A speaker gasket according to claim 1, wherein the thickness of a central portion of the speaker gasket in the width direction is formed smaller than those of portions on both sides of the central portion.

5. A speaker gasket according to claim 4, wherein the speaker gasket is formed in a ring shape and has a plurality of the fixture-through holes formed in positions spaced at equal angular intervals in the ring-shaped speaker gasket, and the thickness of the central portion in the width direction is smaller than those of an inside circumferential edge portion and an outside circumferential edge portion, throughout areas extending between adjacent fixture-through holes of the ring-shaped speaker gasket.

6. A speaker gasket according to claim 1, further comprising a plurality of recesses formed in at least one face of the speaker gasket either that coming into contact with the speaker-mounting site or that coming into contact with the speaker frame, and arranged in a longitudinal direction of the speaker gasket.

7. A speaker gasket according to claim 6, wherein the speaker gasket is formed in a ring shape, and the plurality of recesses are arranged in the circumferential direction on at least one face of the ring-shaped speaker gasket either that coming into contact with the speaker-mounting site or that coming into contact with the speaker frame.

8. A speaker gasket according to claim 7, wherein the plurality of recesses are arranged at equal angular intervals in the circumferential direction of the ring-shaped speaker gasket.

9. A speaker gasket according to claim 7, wherein the plurality of fixture-through holes are respectively formed in the recesses located at equal angular intervals in the ring-shaped speaker gasket.

10. A speaker gasket according to claim 1, wherein at least one face of the speaker gasket either that coming into contact with the speaker-mounting site or that coming into contact with the speaker frame has a sawtooth waveform in the width direction of the speaker gasket.

11. A speaker gasket according to claim 10, wherein the speaker gasket is formed in a ring shape and has a plurality of the fixture-through holes formed in positions spaced at equal angular intervals in the ring-shaped speaker gasket, and the entire portions between adjacent fixture-through holes on at least one face of the speaker gasket have a sawtooth waveform in the width direction of the speaker gasket.
